(19) United States
(12) Patent Application Publication
(10) Pub. No.: US 2023/0034810 A1
(43) Pub. Date: Feb. 2, 2023

(54) METHOD FOR PROCESSING COTTON-CONTAINING TEXTILE WASTE

(71) Applicant: Far Eastern New Century Corporation, Taipei City (TW)

(72) Inventors: Chu-Chin Wang, Taipei City (TW); Chien-Hung Chou, Taipei City (TW); Shu-Yin Shih, Taipei City (TW); Yi-Cyun Jhang, Taipei City (TW)

(21) Appl. No.: 17/546,172

(22) Filed: Dec. 9, 2021

(30) Foreign Application Priority Data
Jul. 22, 2021 (TW) 110127008

(51) Int. Cl. D01G 11/04

(52) U.S. Cl. CPC D01G 11/04; D10B 2201/02

(57) ABSTRACT

A method for processing a cotton-containing textile waste includes: separating cotton fibers from a batch of the textile waste; pretreating the cotton fibers by soaking in a hydroxide-ion-containing solution to obtain a mixture including pretreated carbon fibers; removing a liquid portion from the mixture to obtain the pretreated carbon fibers; subjecting the pretreated carbon fibers to enzymatic hydrolysis to form a sugary juice containing glucose; and e) adding the liquid portion as part of the hydroxide-ion-containing solution for pretreating the cotton fibers separated from a next batch of the textile waste.

### CROSS-REFERENCE TO RELATED APPLICATION

This application claims priority of Taiwanese Invention Patent Application No. 110127008, filed on Jul. 22, 2021.

### FIELD

The disclosure relates to a method for processing a textile waste, and more particularly to a method for processing a cotton-containing textile waste.

### BACKGROUND

Current techniques for processing a cotton-containing textile waste usually involve pretreatment of the cotton-containing textile by soaking the same in a solution so as to raise a cellulose hydrolysis rate in a subsequent enzymatic hydrolysis of the pretreated carbon fibers contained in the cotton-containing textile.

U.S. Pat. No. 9,840,665 B2 discloses a process for producing ethanol from textile cotton. The process includes the steps of: a) grinding textile cotton containing more than 90% cellulose to form ground textile cotton and pulping the ground textile cotton with water in a twin-screw extruder at a temperature of from 60° C. to 180° C. to form a mixture of pretreated textile cotton and water; b) performing enzymatic hydrolysis of the pretreated textile cotton to form a medium including a sugary juice; c) performing filtration of the medium to separate the sugary juice from the medium; and d) fermenting the sugary juice with yeast to obtain ethanol.

U.S. Pat. No. 10,611,891 B2 discloses a method for processing cotton-containing textile waste. The method includes dissolution of the textile waste in a sodium hydroxide/urea solution at a predetermined temperature until the textile waste is frozen; adding an amount of an anti-solvent selected from boiling water and ethanol to regenerate cotton from the frozen textile waste; and hydrolyzing the cotton with cellulase to produce a solution containing glucose.

Although the aforesaid patent documents disclose pretreatment of the cotton-containing textile waste with a soaking solution (water or the sodium hydroxide/urea solution), recycling of the soaking solution is not taught or suggested. In addition, the aforesaid patent documents fail to disclose techniques to maintain the cellulose hydrolysis rate if the soaking solution is to be recycled for degrading the cotton.

### SUMMARY

Therefore, an object of the disclosure is to provide a method for processing a cotton-containing textile waste, in which a soaking solution used for pretreatment of cotton fibers in the cotton-containing textile waste can be recycled while achieving a high cellulose hydrolysis rate.

According to the disclosure, there is provided a method for processing a cotton-containing textile waste. The method includes the steps of:

a) separating cotton fibers from a batch of the cotton-containing textile waste;

b) pretreating the cotton fibers by soaking in a hydroxide-ion-containing solution to obtain a mixture including pretreated carbon fibers;

c) removing a liquid portion from the mixture to obtain the pretreated carbon fibers;

d) subjecting the pretreated carbon fibers to enzymatic hydrolysis so as to hydrolyze cellulose contained in the pretreated carbon fibers to form a sugary juice containing glucose; and

e) adding the liquid portion as part of the hydroxide-ion-containing solution for pretreating the cotton fibers separated from a next batch of the cotton-containing textile waste.

### BRIEF DESCRIPTION OF THE DRAWINGS

Other features and advantages of the disclosure will become apparent in the following detailed description of the embodiment(s) with reference to the accompanying drawings, in which:

FIGS. 1A and 1B are flow diagrams illustrating the procedures performed in Examples 1 to 5 and Comparative Examples 1 to 3 described below.

### DETAILED DESCRIPTION

A method for processing a cotton-containing textile waste according to the disclosure includes the steps of:

a) separating cotton fibers from a batch of the cotton-containing textile waste;

b) pretreating the cotton fibers by soaking in a hydroxide-ion-containing solution to obtain a mixture including pretreated carbon fibers;

c) removing a liquid portion from the mixture to obtain the pretreated carbon fibers;

d) subjecting the pretreated carbon fibers to enzymatic hydrolysis so as to hydrolyze cellulose contained in the pretreated carbon fibers to form a sugary juice containing glucose; and

e) adding the liquid portion as part of the hydroxide-ion-containing solution for pretreating the cotton fibers separated from a next batch of the cotton-containing textile waste.

Processing Procedure:

Separation Step:

The source of the cotton-containing textile waste may include, for example, cotton-containing waste clothing, but is not limited thereto. The cotton-containing textile waste contains cotton fibers and a material other than the cotton fibers. In some embodiments, an amount of the cotton fibers in the cotton-containing textile waste may range, for example, from 35 wt % to 50 wt % based on a total weight of the cotton-containing textile waste, but is not limited thereto.

Examples of the material other than the cotton fibers may include dyes and non-cotton fibers, but are not limited thereto. An example of the non-cotton fibers may be polyester fibers, but is not limited thereto. When the polyester fibers are included in the cotton-containing textile waste, they can be degraded by a degradation process, such as alkaline hydrolysis, alcoholysis, or a combination thereof, so as to separate and recycle the cotton fibers from the cotton-containing textile waste.

In some embodiments, the alkaline hydrolysis is performed by treating the cotton-containing textile waste with an alkaline material having a pH value ranging from 10 to 14 at a pressure ranging from 1 kg/cm² to 8 kg/cm² and a temperature ranging from 160° C. to 180° C. to degrade the polyester fibers. In some embodiments, a weight ratio of the alkaline material to the cotton-containing textile waste may range from 5:1 to 10:1. In some embodiments, examples of the alkaline material may include alkaline compounds and an aqueous solution of the alkaline compounds, but are not limited thereto. Examples of the alkaline material suitable for the method for processing a cotton-containing textile waste according to the disclosure may be any alkaline compound having a pH value of from 10 to 14. A non-limiting example of the alkaline material is sodium hydroxide.

In some embodiments, the alcoholysis is performed by treating the cotton-containing textile waste with ethylene glycol at a pressure ranging from 1 kg/cm² to 2 kg/cm² and a temperature ranging from 160° C. to 200° C. to degrade the polyester fibers.

Pretreatment Step:

Examples of the hydroxide-ion-containing solution for pretreating the cotton fibers separated from the cotton-containing textile waste may include water and an aqueous solution of sodium hydroxide, but are not limited thereto. In some embodiments, the hydroxide-ion-containing solution used in step b) includes hydroxide ions at a concentration ranging from 1.0×10⁻⁷ M to 3.0 M so as to reduce polymerization degree and crystallinity of cellulose contained in the cotton fibers, such that a higher cellulose hydrolysis rate can be obtained by the method for processing a cotton-containing textile waste according to the disclosure. In some embodiments, the hydroxide-ion-containing solution includes hydroxide ions at a concentration ranging from 1.5 M to 3.0 M.

In some embodiments, in step b), a weight ratio of the cotton fibers to the hydroxide-ion-containing solution ranges from 1:5 to 1:19 so as to increase the cellulose hydrolysis rate obtained by the method for processing a cotton-containing textile waste according to the disclosure.

Removal Step:

In some embodiments, step c) involves performing filtration with filter paper.

In some embodiments, the pretreated carbon fibers obtained in step c) may be optionally washed with water. There is no limitation to a ratio of water to the pretreated carbon fibers. The amount of water for washing the pretreated carbon fibers may be adjusted suitably according to the amount of the pretreated carbon fibers.

Enzymatic Hydrolysis:

In step d), there is no limitation to the operating conditions for the enzymatic hydrolysis, which may be adjusted suitably according to the specific cellulase used for the enzymatic hydrolysis. In some embodiments, the enzymatic hydrolysis is performed at a pH value of about 5 and a temperature of about 50° C.

Recycling Procedure:

In order to maintain an amount of the next batch of the cotton-containing textile waste to be processed by the method according to the disclosure and the weight ratio of the cotton fibers to the hydroxide-ion-containing solution in step b) of the method according to the disclosure for processing the next batch of the cotton-containing textile waste, the method according to the disclosure may further include, prior to step e), adding to the liquid portion, a fresh hydroxide-ion-containing solution containing hydroxide ions at a concentration which is the same as that of the hydroxide ions in the hydroxide-ion-containing solution used in step b). The fresh hydroxide-ion-containing solution is added in an amount such that a total weight of the liquid portion and the fresh soaking solution is equal to a weight of the hydroxide-ion-containing solution for pretreating the cotton fibers separated from the next batch of the cotton-containing textile waste.

In some embodiments, steps a), b), c), and d) (i.e., the separation, pretreatment, removal, and enzymatic hydrolysis steps) are performed for at least four times. In some embodiments, steps a), b), c), and d) are performed for six times, and a cellulose hydrolysis rate obtained after performing step d) for six times is decreased by a ratio of less than 4.5% compared to the cellulose hydrolysis rate obtained after performing step d) for one time.

Examples of the disclosure will be described hereinafter. It is to be understood that these examples are exemplary and explanatory and should not be construed as a limitation to the disclosure.

### Test Examples A1 to A10

Discussion of Hydroxide Ion Concentration in Hydroxide-Ion-Containing Solution:

Test Examples A1 to A10 are the examples for discussing various conditions of the ion-containing solution used in the pretreatment step of the method for processing a cotton-containing textile waste.

Test Examples A1 to A5 were subjected to substantially similar steps except that the hydroxide ion-containing solutions with the conditions shown in Table 1 below were used. Therefore, only Test Example A1 is illustrated in detail below.

Separation:

A crusher equipped with a 25 mm filter (purchased from Shuen Li Machinery Co., Ltd., Taiwan) was used to crush a cotton-containing textile waste (purchased from Shee Yi Co., Ltd., Taiwan), which included cotton fibers and polyethylene terephthalate fibers (hereinafter referred to as PET fibers), into fragments. Fragments having a size of 15 mm×15 mm were then collected for subsequent alkaline hydrolysis. Then, the collected fragments and an alkaline solution were put into a zirconium high-pressure reactor (Manufacturer: Zimmerman Scientific Co., Ltd., Model No.: PARR 20L), and the alkaline hydrolysis was performed at a temperature of from 160° C. to 170° C. and a pressure of from 6 kg/cm² to 8 kg/cm² for 300 minutes so that the alkaline solution degrades the PET fibers in the collected fragments. After the alkaline hydrolysis was completed, a solid-liquid separation was performed using a quantitative filter paper (Manufacturer: ADVANTEC, Grade: NO. 5C) to recycle the cotton fibers from the collected fragments. The alkaline solution was made of water and sodium hydroxide. A weight ratio of the alkaline solution to the collected fragments was 10:1, and an equivalent ratio of sodium hydroxide to the PET fibers in the collected fragments was 2.5:1.

Pretreatment:

The cotton fibers thus obtained were soaked in a hydroxide-ion-containing solution at 25° C. with stirring for 3 hours to obtain a mixture. The hydroxide-ion-containing solution was made of water and sodium hydroxide, and included hydroxide ions at a concentration of 3.0 M. The concentration of sodium hydroxide in the hydroxide-ion-containing solution was 12 wt %. A weight ratio of the cotton fibers to the hydroxide-ion-containing solution was 1:19.

Removal:

The mixture was subjected to a solid-liquid separation using the quantitative filter paper (Manufacturer: ADVANTEC, Grade: NO. 5C) so as to separate the mixture into a liquid portion and a solid portion including pretreated carbon fibers. The solid portion was washed with water, in which a weight ratio of water to the solid portion was 20:1.

Enzymatic Hydrolysis:

After performing the solid-liquid separation of the mixture, the solid portion was mixed with water and 96% sulfuric acid to adjust the pH value to 5.0. A cellulase (Manufacturer: Novozymes, Model No.: Cellic® CTec 3) was then added, and a saccharification reaction was performed at a temperature of 50° C. and a stirring speed of 200 rpm for 120 hours. At the 2^{nd}, 4^{th}, 6^{th} and 24^{th} hour after the start of the saccharification reaction, 96% sulfuric acid was added to maintain the pH value at 5.0. The cellulose in the pretreated cotton fiber was degraded by the saccharification reaction into a sugary juice containing glucose by the cellulase.

Test Examples A6 to A10 were performed using steps similar to those of Test Examples A1 to A5, except that the collected fragments of the cotton-containing textile waste were soaked directly in the hydroxide-ion-containing solution without degradation of the PET fibers in the collected fragments by the alkaline solution, and that the ion-containing solutions with the conditions shown in Table 2 were used for pretreating the fragments.

The cellulose hydrolysis rate of each of Test Examples A1 to A10 was obtained by an evaluation method described below.

The glucose content of the sugary juice was analyzed by high performance liquid chromatography with an Aminex HPX-87H column (purchased from Bio-Rad) at a temperature of 65° C., a mobile phase of 5 mM sulfuric acid, and a flow rate of 0.6 mL/min. A refractive index detector (purchased from Hitachi; Model no.: L-2490) was used as a detector.

A glucose standard and the solid portion were dried in an oven at a temperature of 105° C. until the weights thereof were stabilized. After that, 0.3 g of each of the dried glucose standard and the dried solid portion was weighed and added together into a test tube. 3.00 mL (4.92 g) of 72% sulfuric acid (purchased from ECHO Chemical Co., Ltd., Taiwan) was added into the test tube. The test tube was then placed in a water bath set at 30° C. for 2 hours to obtain a first hydrolysis solution. After that, the first hydrolysis solution in the test tube was poured into a conical flask, and then 20 mL of deionized water was used to wash the test tube and poured into the conical flask so as to mix with the first hydrolysis solution to obtain a mixture solution. Then, 64 mL of deionized water was added to the conical flask to dilute the sulfuric acid in the mixture solution to a concentration of 4% (1.0250 g/mL) so as to obtain a diluted mixture solution with a volume of 87.0 mL and a weight of 89.22 g. Then, the opening of the conical flask was sealed with aluminum foil, and the conical flask was put into a sterilization kettle at 121° C. to hydrolyze the diluted mixture solution therein for 1 hour so as to obtain a second hydrolysis solution. Finally, 20 mL of the second hydrolysis solution was placed in a 50 mL beaker, and the pH value of the second hydrolysis solution was adjusted with calcium carbonate (purchased from Uni-Onward Corp., Taiwan) to a value of from 5 to 6. The second hydrolysis solution was then left to stand until a solid and a liquid portion were separated. After that, a supernatant was obtained, and was centrifuged at 13,200 rpm for 10 minutes, and a syringe with a filter of 0.2 μm pore size was used to filter and sample to obtain a test solution. The glucose content in the solid portion was obtained by subjecting the test solution to high performance liquid chromatography according to the same analytical conditions as described above. The cellulose content in the solid portion was calculated using an equation shown below.

Cc=Cg/1.111

wherein

Cc is the cellulose content in the solid portion in grams;

Cg is the glucose content in the solid portion in grams; and

1.111 is a dehydration coefficient of hydrolysis of cellulose into glucose.

The cellulose hydrolysis rate was calculated using an equation shown below.

Rh=Csg/(Cc×1.111)

wherein

Rh is the cellulose hydrolysis rate in %;

Csg is the glucose content of the sugary juice in grams; and

Cc is the cellulose content in the solid portion in grams.

TABLE 1

| Test Examples | | A1 | A2 | A3 | A4 | A5 |
|---|---|---|---|---|---|---|
| Cotton fiber content in cotton-containing | | 35 | 35 | 35 | 35 | 35 |
| textile waste (%) | | | | | | |
| Separation | | Alkaline | Alkaline | Alkaline | Alkaline | Alkaline |
| | | hydrolysis | hydrolysis | hydrolysis | hydrolysis | hydrolysis |
| Pretreatment | Hydroxide ion concentration | 3 | 2.5 | 2.25 | 1.5 | 10⁻⁷ |
| | in hydroxide-ion-containing | | | | | |
| | solution (M) | | | | | |
| | Sodium hydroxide concentration | 12 | 10 | 9 | 6 | 0 |
| | in hydroxide-ion-containing | | | | | |
| | solution (wt %) | | | | | |
| | Weight ratio of cotton fibers | 1:19 | 1:19 | 1:19 | 1:19 | 1:19 |
| | to hydroxide-ion-containing | | | | | |
| | solution | | | | | |
| Enzymatic | Cellulose hydrolysis rate (%) | 75.7 | 55.5 | 45.0 | 28.8 | 22.9 |
| hydrolysis | | | | | | |

TABLE 2

| Test Examples | | A6 | A7 | A8 | A9 | A10 |
|---|---|---|---|---|---|---|
| Cotton fiber content in cotton-containing textile waste (%) | | 35 | 35 | 35 | 35 | 35 |
| Separation | | — | — | — | — | — |
| Pretreatment | Hydroxide ion concentration in | 3 | 2.5 | 2.25 | 1.5 | 10⁻⁷ |
| | hydroxide-ion-containing solution (M) | | | | | |
| | Sodium hydroxide concentration in | 12 | 10 | 9 | 6 | 0 |
| | hydroxide-ion-containing solution (wt %) | | | | | |
| | Weight ratio of cotton fibers to | 1:19 | 1:19 | 1:19 | 1:19 | 1:19 |
| | hydroxide-ion-containing solution | | | | | |
| Enzymatic | Cellulose hydrolysis rate (%) | 60.5 | 32.9 | 25.5 | 16.6 | 12.1 |
| hydrolysis | | | | | | |

As shown in Tables 1 and 2, when the hydroxide-ion-containing solution with the same hydroxide ion concentration is used for pretreating the cotton fibers, the cellulose hydrolysis rates obtained in Test Examples A1 to A5, in which the alkaline hydrolysis is performed to separate the cotton fibers from the cotton-containing textile waste, are higher than those obtained in Test Examples A6 to A10, in which the alkaline hydrolysis is not performed. Moreover, among Test Examples A1 to A5, in which the alkaline hydrolysis is performed, the cellulose hydrolysis rates obtained in Test Examples A1 and A2, in which the hydroxide ion concentrations in the hydroxide-ion-containing solutions are 3.0 M and 2.5 M, respectively, are both greater than 50%.

### Test Examples B1 to B8

Discussion of Weight Ratio of Cotton Fibers to Hydroxide-Ion-Containing Solution in Pretreatment Step:

Test Examples B1 to B8 were subjected to pretreatment using hydroxide-ion-containing solutions each having a concentration of 3.0 M, and the pretreatment was carried out according the procedures described above for Test Examples A1 to A10 with the weight ratios of the cotton fibers to the hydroxide-ion-containing solutions shown in Tables 3 and 4 below.

TABLE 3

| Test Examples | | B1 | B2 | B3 | B4 |
|---|---|---|---|---|---|
| Cotton fiber content in cotton-containing | | 35 | 35 | 35 | 35 |
| textile waste (%) | | | | | |
| Separation | | Alkaline | Alkaline | Alkaline | Alkaline |
| | | hydrolysis | hydrolysis | hydrolysis | hydrolysis |
| Pretreatment | Hydroxide ion concentration | 3 | 3 | 3 | 3 |
| | in hydroxide-ion-containing | | | | |
| | solution (M) | | | | |
| | Weight ratio of cotton fibers | 1:5 | 1:10 | 1:16 | 1:19 |
| | to hydroxide-ion-containing | | | | |
| | solution | | | | |
| Enzymatic | Cellulose hydrolysis rate (%) | 63.4 | 79.4 | 77.2 | 75.7 |
| hydrolysis | | | | | |

TABLE 4

| Test Examples | | B5 | B6 | B7 | B8 |
|---|---|---|---|---|---|
| Cotton fiber content in cotton-containing | | 35 | 35 | 35 | 35 |
| textile waste (%) | | | | | |
| Separation | | — | — | — | — |
| Pretreatment | Hydroxide ion concentration | 3 | 3 | 3 | 3 |
| | in hydroxide-ion-containing | | | | |
| | solution (M) | | | | |
| | Weight ratio of cotton fibers | 1:5 | 1:10 | 1:16 | 1:19 |
| | to hydroxide-ion-containing | | | | |
| | solution | | | | |
| Enzymatic | Cellulose hydrolysis rate (%) | 50.2 | 65.7 | 58.2 | 60.5 |
| hydrolysis | | | | | |

As shown in Tables 3 and 4, when the weight ratio of the cotton fibers to the hydroxide-ion-containing solution used for pretreating is the same, the cellulose hydrolysis rates obtained in Test Examples B1 to B4, in which the alkaline hydrolysis is performed to separate the cotton fibers from the cotton-containing textile waste, are higher than those obtained in Test Examples B5 to B8, in which the alkaline hydrolysis is not performed. Moreover, among Test Examples B1 to B4, in which the alkaline hydrolysis is performed, the cellulose hydrolysis rates obtained in Test Examples B2 to B4, in which the weight ratios of the cotton fibers to the hydroxide-ion-containing solutions are 1:10, 1:16, and 1:19, respectively, are all greater than 70%.

### Examples 1 to 3 and Comparative Examples 1 to 3

Examples 1 to 3 were subjected to alkaline hydrolysis for separating the cotton fibers from the cotton-containing textile waste. In contrast, alkaline hydrolysis for separating the cotton fibers from the cotton-containing textile waste was not carried out in Comparative Examples 1 to 3. Examples 1 to 3 and Comparative Examples 1 to 3 were subjected to procedures which were substantially the same. The operation conditions shown in Tables 5 to 10 below were used. Therefore, only Example 1 is illustrated in detail below.

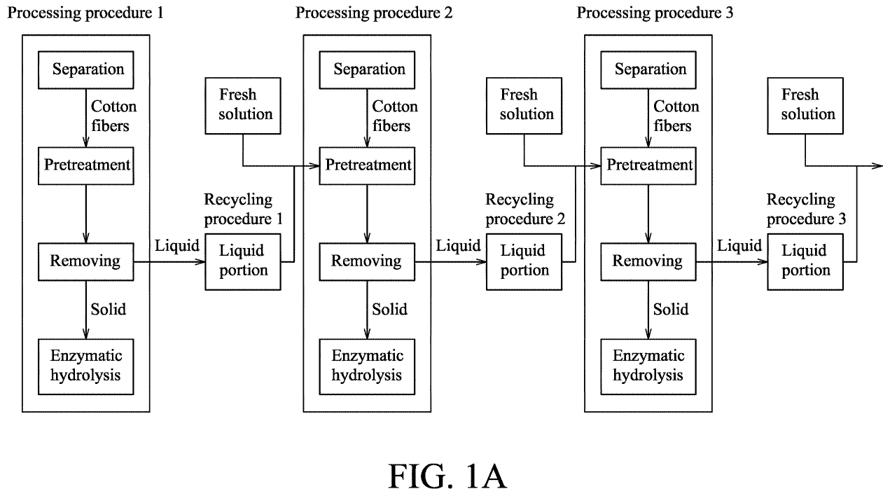

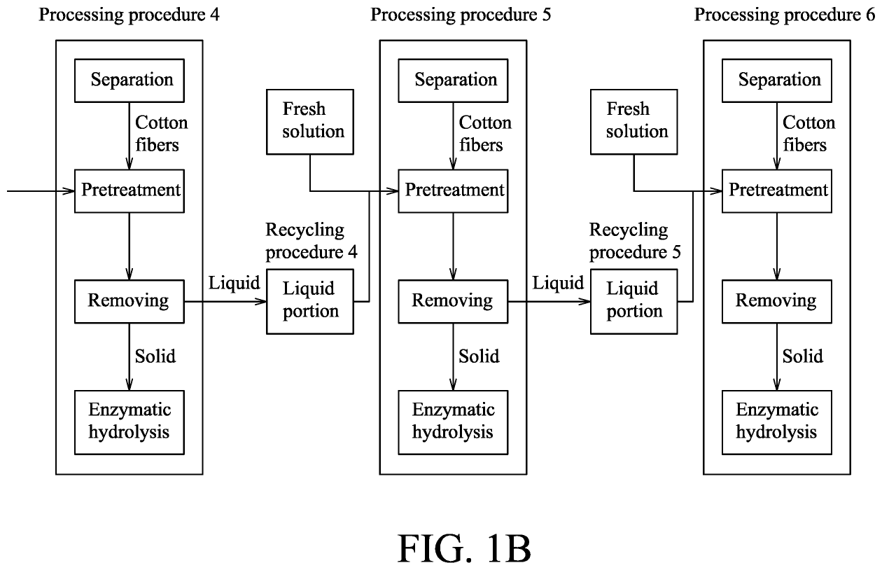

Referring to FIGS. 1A and 1B, Example 1 was subjected to processing procedure 1, recycling procedure 1, processing procedure 2, recycling procedure 2, processing procedure 3, recycling procedure 3, processing procedure 4, recycling procedure 4, processing procedure 5, recycling procedure 5, and processing procedure 6 in sequence. Each of the processing procedures 1 to 6 was performed by processing a batch of the cotton-containing textile waste according to the separation, pretreatment, removal, and enzymatic hydrolysis steps described above in Test Examples A1 to A10.

The amount of the cotton-containing textile waste to be processed in each of the processing procedures 1 to 6 was fixed to have the same weight. Therefore, in each of the recycling procedures 1 to 5, in order to maintain the weight ratio of the cotton fibers to the hydroxide-ion-containing solution in a range of from 1:5 to 1:19 and the hydroxide ions in the hydroxide-ion-containing solution at a concentration of 2.5 M in the pretreatment step of the next processing procedure, a fresh hydroxide-ion-containing solution containing the hydroxide ions at a concentration of 2.5 M was added to the liquid portion obtained in the removal step of each of processing procedures 1 to 5 in an amount such that a total weight of the liquid portion and the fresh soaking solution was equal to a weight of the hydroxide-ion-containing solution for pretreating the cotton fibers separated from the next batch of the cotton-containing textile waste. For example, in recycling procedure 1, a fresh hydroxide-ion-containing solution containing hydroxide ions at a concentration of 2.5 M was added to the liquid portion obtained in the removal step of processing procedure 1 in an amount such that a total weight of the liquid portion and the fresh soaking solution was equal to a weight of the hydroxide-ion-containing solution for pretreating the cotton fibers separated from the next batch of the cotton-containing textile waste in the pretreatment step of processing procedure 2.

TABLE 5

| | | Example 1 | | | | | |
|---|---|---|---|---|---|---|---|
| Cotton fiber content in cotton-containing | | 35 | | | | | |
| textile waste (%) | | | | | | | |
| Separation | | Alkaline hydrolysis | | | | | |
| Pretreatment | Hydroxide ion concentration | 2.5 | | | | | |
| | in hydroxide-ion-containing | | | | | | |
| | solution (M) | | | | | | |
| | Weight ratio of cotton fibers | 1:19 | | | | | |
| | to hydroxide-ion-containing | | | | | | |
| | solution | | | | | | |
| Processing | Cellulose hydrolysis rate (%) | P. P.* 1 | P. P. 2 | P. P. 3 | P. P. 4 | P. P. 5 | P. P. 6 |
| procedures | | 55.5 | 56.9 | 57.2 | 56.0 | 56.4 | 55.0 |

*P. P.: processing procedure

TABLE 6

| | | Comparative Example 1 | | | | | |
|---|---|---|---|---|---|---|---|
| Cotton fiber content in cotton-containing | | 35 | | | | | |
| textile waste (%) | | | | | | | |
| Separation | | — | | | | | |
| Pretreatment | Hydroxide ion concentration | 2.5 | | | | | |
| | in hydroxide-ion-containing | | | | | | |
| | solution (M) | | | | | | |
| | Weight ratio of cotton fibers | 1:19 | | | | | |
| | to hydroxide-ion-containing | | | | | | |
| | solution | | | | | | |
| Processing | Cellulose hydrolysis rate (%) | P. P. 1 | P. P. 2 | P. P. 3 | P. P. 4 | P. P. 5 | P. P. 6 |
| procedures | | 32.9 | 33.8 | 32.9 | 30.1 | 30.3 | 29.5 |

* P. P.: processing procedure

TABLE 7

| | | Example 2 | | | | | |
|---|---|---|---|---|---|---|---|
| Cotton fiber content in cotton-containing | | 35 | | | | | |
| textile waste (%) | | | | | | | |
| Separation | | Alkaline hydrolysis | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:19 | | | | | |
| | to hydroxide-ion-containing | | | | | | |
| | solution | | | | | | |
| Processing | Cellulose hydrolysis rate (%) | P. P.* 1 | P. P. 2 | P. P. 3 | P. P. 4 | P. P. 5 | P. P. 6 |
| procedures | | 75.7 | 76.1 | 75.7 | 76.4 | 73.3 | 74.2 |

*P. P.: processing procedure

TABLE 8

| | | Comparative Example 2 | | | | | |
|---|---|---|---|---|---|---|---|
| Cotton fiber content in cotton-containing | | 35 | | | | | |
| textile waste (%) | | | | | | | |
| Separation | | — | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:19 | | | | | |
| | to hydroxide-ion-containing | | | | | | |
| | solution | | | | | | |
| Processing | Cellulose hydrolysis rate (%) | P. P. 1 | P. P. 2 | P. P. 3 | P. P. 4 | P. P. 5 | P. P. 6 |
| procedures | | 60.5 | 60.3 | 59.5 | 57.6 | 51.9 | 50.2 |

* P. P.: processing procedure

TABLE 9

| | | Example 3 | | | | | |
|---|---|---|---|---|---|---|---|
| Cotton fiber content in cotton-containing | | 35 | | | | | |
| textile waste (%) | | | | | | | |
| Separation | | Alkaline hydrolysis | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:16 | | | | | |
| | to hydroxide-ion-containing | | | | | | |
| | solution | | | | | | |
| Processing | Cellulose hydrolysis rate (%) | P. P.* 1 | P. P. 2 | P. P. 3 | P. P. 4 | P. P. 5 | P. P. 6 |
| procedures | | 77.2 | 78.4 | 76.5 | 75.7 | 74.6 | 74 |

*P. P.: processing procedure

TABLE 10

| | | Comparative Example 3 | | | | | |
|---|---|---|---|---|---|---|---|
| Cotton fiber content in cotton-containing | | 35 | | | | | |
| textile waste (%) | | | | | | | |
| Separation | | — | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:16 | | | | | |
| | to hydroxide-ion-containing | | | | | | |
| | solution | | | | | | |
| Processing | Cellulose hydrolysis rate (%) | P. P. 1 | P. P. 2 | P. P. 3 | P. P. 4 | P. P. 5 | P. P. 6 |
| procedures | | 58.2 | 58.8 | 57.6 | 55.6 | 52.8 | 48.6 |

* P. P.: processing procedure

As shown in Tables 5 and 6, the cellulose hydrolysis rate obtained in Example 1, in which alkaline hydrolysis is performed to separate the cotton fibers from the cotton-containing textile waste, is higher than that obtained in Comparative Example 1, in which the alkaline hydrolysis is not performed, provided that the operation conditions of the pretreatment step (i.e., the hydroxide ion concentration in the hydroxide-ion-containing solution and the weight ratio of the cotton fibers to the hydroxide-ion-containing solution) are fixed to be the same. Referring to Tables 7 to 10, the results of Examples 2 and 3 and Comparative Examples 2 and 3 also show similar trend, i.e., the cellulose hydrolysis rates obtained in Examples 2 and 3 are higher than those obtained in Comparative Examples 2 and 3, respectively. The above results show that by preforming the alkaline hydrolysis to separate the cotton fibers from the cotton-containing textile waste, the cellulose hydrolysis rates obtained by the method for processing a cotton-containing textile waste of this disclosure can be increased.

Moreover, in Example 1, compared to the cellulose hydrolysis rate obtained in processing procedure 1, the cellulose hydrolysis rate obtained in processing procedure 6 is decreased only by 0.9% [i.e., (55.5−55.0)÷55.5×100%=0.9%]. However, in Comparative Example 1, compared to the cellulose hydrolysis rate obtained in processing procedure 1, the cellulose hydrolysis rate obtained in processing procedure 6 is decreased by 10.33% [i.e., (32.9−29.5)÷32.9×100%=10.33%]. In Example 2, compared to the cellulose hydrolysis rate obtained in processing procedure 1, the cellulose hydrolysis rate obtained in processing procedure 6 is decreased only by 1.98% [i.e., (75.7−74.2)÷75.7×100%=1.98%]. However, in Comparative Example 2, compared to the cellulose hydrolysis rate obtained in processing procedure 1, the cellulose hydrolysis rate obtained in processing procedure 6 is decreased by 17.02% [(60.5−50.2)÷60.5×100%=17.02%]. In Example 3, compared to the cellulose hydrolysis rate obtained in processing procedure 1, the cellulose hydrolysis rate obtained in processing procedure 6 is decreased only by 4.15% [i.e., (77.2−74)÷77.2×100%=4.15%]. However, in Comparative Example 3, compared to the cellulose hydrolysis rate obtained in processing procedure 1, the cellulose hydrolysis rate obtained in processing procedure 6 is decreased by 16.49% [i.e., (58.2−48.6)÷58.2×100%=16.49%]. The above results show that by preforming the alkaline hydrolysis to separate the cotton fibers from the cotton-containing textile waste, it is also possible to implement the method for processing a cotton-containing textile waste of this disclosure in such a way that even if the recycling procedure is performed, it does not result in a significant decrease in the cellulose hydrolysis rate obtained in the next processing procedure.

### Example 4

Example 4 was performed according to the processing procedures and the recycling procedures similar to those described above for Example 1 except that the operation conditions shown in Table 11 below were used.

TABLE 11

| | | Example 4 | | | | | |
|---|---|---|---|---|---|---|---|
| Cotton fiber content in cotton-containing | | 50 | | | | | |
| textile waste (%) | | | | | | | |
| Separation | | Alkaline hydrolysis | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:19 | | | | | |
| | to hydroxide-ion-containing | | | | | | |
| | solution | | | | | | |
| Processing | Cellulose hydrolysis rate (%) | P. P.* 1 | P. P. 2 | P. P. 3 | P. P. 4 | P. P. 5 | P. P. 6 |
| procedures | | 75.0 | 76.4 | 75.1 | 73.7 | 74.8 | 74.1 |

*P. P.: processing procedure

As shown in Table 11, even if the cotton fiber content of the cotton-containing textile waste is as high as 50%, a high cellulose hydrolysis rate can still be obtained by the method for processing a cotton-containing textile waste according to the disclosure, in which alkaline hydrolysis is performed to separate the cotton fibers from the cotton-containing textile waste. In addition, the results of Examples 1 to 4 demonstrate that the method for processing a cotton-containing textile waste according to the disclosure is suitable for treating cotton-containing textile wastes with various cotton fiber contents and can still obtain a high cellulose hydrolysis rate. Furthermore, in Example 4, even after five recycling procedures, the cellulose hydrolysis rate obtained in processing procedure 6 is decreased only by 1.2% [i.e., (75.0-74.1)÷75.0×100%=1.2%], compared to the cellulose hydrolysis rate obtained in processing procedure 1.

### Example 5

Example 5 was subjected to processing procedures and recycling procedures similar to those described above for Example 1 except for the following differences.

The operation conditions shown in Table 12 below were used. In addition, in each of the separation steps of processing procedures 1 to 6 of Example 5, a crusher equipped with a 25 mm filter (purchased from Shuen Li Machinery Co., Ltd., Taiwan) was used to crush a cotton-containing textile waste (purchased from Shee Yi Co., Ltd., Taiwan), which included cotton fibers and PET fibers, into multiple fragments. Fragments having a size of 15 mm×15 mm were then collected. Then, the collected fragments and ethylene glycol were put into a glass reactor with a weight ratio of ethylene glycol to the collected fragments being 6:1. Alcoholysis was performed at a temperature of 180° C. and a pressure of 1 kg/cm² for 180 minutes. After completion of alcoholysis, heating of the glass reactor was stopped, and sodium hydroxide was added into the glass reactor in an equivalent ratio of sodium hydroxide to the PET fibers in the collected fragments of 2.01:1. Alkaline hydrolysis was performed at a temperature of 180° C. and a pressure of 1 kg/cm² for 180 minutes. After completion of alkaline hydrolysis, a solid-liquid separation was performed using a quantitative filter paper (Manufacturer: ADVANTEC, Grade: NO. 5C) to recycle the cotton fibers from the collected fragments.

TABLE 12

| | | Example 5 | | | | | |
|---|---|---|---|---|---|---|---|
| Cotton fiber content in cotton-containing | | 50 | | | | | |
| textile waste (%) | | | | | | | |
| Separation | | Alcoholysis & alkaline hydrolysis | | | | | |
| Pretreatment | Hydroxide ion concentration | 3.0 | | | | | |
| | in hydroxide-ion-containing | | | | | | |
| | solution (M) | | | | | | |
| | Weight ratio of cotton fibers | 1:16 | | | | | |
| | to hydroxide-ion-containing | | | | | | |
| | solution | | | | | | |
| Processing | Cellulose hydrolysis rate (%) | P. P.* 1 | P. P. 2 | P. P. 3 | P. P. 4 | P. P. 5 | P. P. 6 |
| procedures | | 79.5 | 79.1 | 82.0 | 82.2 | 79.1 | 78.4 |

*P. P.: processing procedure

As shown in Table 12, when the separation step involves alcoholysis and alkaline hydrolysis, a high cellulose hydrolysis rate can also be obtained by the method for processing a cotton-containing textile waste according to the disclosure. Moreover, in Example 5, even after performing five rounds of recycling procedures, the cellulose hydrolysis rate obtained in processing procedure 6 is decreased only by 1.38% [i.e., (79.5−78.4)÷79.5×100%=1.38%], compared to the cellulose hydrolysis rate obtained in processing procedure 1.

In summary, a high cellulose hydrolysis rate can be obtained by the method for processing a cotton-containing textile waste according to the disclosure, in which the separation, pretreatment, removal, and enzymatic hydrolysis steps are performed. Specifically, separation of the cotton fibers from the cotton-containing textile waste is performed by, for example, alcoholysis or alkaline hydrolysis, so that a high cellulose hydrolysis rate obtained by the method for processing a cotton-containing textile waste according to the disclosure can be increased by at least 10%, compared to that obtained by a method for processing a cotton-containing textile waste in which the separation step is not performed. Furthermore, separation of the cotton fibers from the cotton-containing textile waste is performed in the method for processing a cotton-containing textile waste according to the disclosure, so that even if the recycling procedure is performed to add the liquid portion obtained in the removal step as part of the hydroxide-ion-containing solution for pretreating the cotton fibers separated from a next batch of the cotton-containing textile waste, the cellulose hydrolysis rate obtained in the next processing procedure is not decreased significantly.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for processing a cotton-containing textile waste, comprising the steps of:
a) separating cotton fibers from a batch of the cotton-containing textile waste;
b) pretreating the cotton fibers by soaking in a hydroxide-ion-containing solution to obtain a mixture including pretreated carbon fibers;
c) removing a liquid portion from the mixture to obtain the pretreated carbon fibers;
d) subjecting the pretreated carbon fibers to enzymatic hydrolysis so as to hydrolyze cellulose contained in the pretreated carbon fibers to form a sugary juice containing glucose; and
e) adding the liquid portion as part of the hydroxide-ion-containing solution for pretreating the cotton fibers separated from a next batch of the cotton-containing textile waste.

2. The method according to claim 1, wherein in step a), the cotton-containing textile waste includes polyester fibers which are subjected to a degradation process selected from the group consisting of alkaline hydrolysis, alcoholysis, and a combination thereof so as to separate the cotton fibers from the cotton-containing textile waste.

3. The method according to claim 2, wherein the alkaline hydrolysis is performed by treating the cotton-containing textile waste with an alkaline material at a pressure ranging from 1 kg/cm² to 8 kg/cm² and a temperature ranging from 160° C. to 180° C.

4. The method according to claim 2, wherein the alcoholysis is performed by treating the cotton-containing textile waste with ethylene glycol at a pressure ranging from 1 kg/cm² to 2 kg/cm² and a temperature ranging from 160° C. to 200° C.

5. The method according to claim 1, wherein in step b), the hydroxide-ion-containing solution includes hydroxide ions at a concentration ranging from 1.0×10⁻⁷ M to 3.0 M.

6. The method according to claim 5, wherein the hydroxide-ion-containing solution includes the hydroxide ions at a concentration ranging from 1.5 M to 3.0 M.

7. The method according to claim 1, wherein in step b), a weight ratio of the cotton fibers to the hydroxide-ion-containing solution ranges from 1:5 to 1:19.

8. The method according to claim 1, further comprising, prior to step e), adding to the liquid portion, a fresh hydroxide-ion-containing solution containing the hydroxide ions at a concentration which is the same as that of the hydroxide ions in the hydroxide-ion-containing solution, the fresh hydroxide-ion-containing solution being added in an amount such that a total weight of the liquid portion and the fresh soaking solution is equal to a weight of the hydroxide-ion-containing solution for pretreating the cotton fibers separated from the next batch of the cotton-containing textile waste.

9. The method according to claim 1, wherein steps a), b), c), and d) are performed for at least four times.

10. The method according to claim 9, wherein steps a), b), c), and d) are performed for six times, and a cellulose hydrolysis rate obtained after performing step d) for six times is decreased by a ratio of less than 4.5% compared to the cellulose hydrolysis rate obtained after performing step d) for one time.
